(19) United States
(12) Patent Application Publication
(10) Pub. No.: US 2025/0387825 A1
(43) Pub. Date: Dec. 25, 2025

(54) INDEXING SYSTEM FOR A MULTI-STATION PROCESSING APPARATUS

(71) Applicant: John Bean Technologies N.V., Sint-Niklaas (BE)

(72) Inventor: Maarten De Ridder, Kuitaart (NL)

(73) Assignee: John Bean Technologies N.V., Sint-Niklaas (BE)

(21) Appl. No.: 18/873,986

(22) PCT Filed: Jun. 16, 2023
(86) PCT No.: PCT/IB2023/056283

§ 371 Date: Dec. 11, 2024

Related U.S. Application Data
(60) Provisional application No. 63/366,959, filed on Jun. 24, 2022.

(51) Int. Cl. B21D 43/14; B21D 43/02

(52) U.S. Cl. CPC B21D 43/14; B21D 43/027

(57) ABSTRACT

An indexing system for a multi-head seamer apparatus for scaling the tops of containers includes a multi-position indexing platform having a plurality of stations arranged along an arcuate path about an axis (62), including a receiving station (44) for receiving containers to which covers are to be sealed, and a diametrically located discharge station (46) from which containers with covers sealed thereto are removed from the platform (20). At least two sealing stations (48. 50) are provided where at covers are scaled to the containers. A first sealing station (48) is positioned on the arcuate path extending clockwise from the receiving station (44) toward the discharge station (46), and a second sealing station (50) positioned on the arcuate path extending counterclockwise from the receiving station (44) toward the discharge station (46). A pivot arm assembly (60) is rotatable about the pivot axis (62) to move the containers from the receiving station (44) in a clockwise direction to the first sealing station (48) and in a counterclockwise direction to the second sealing station (50).

### CROSS-REFERENCE TO RELATED APPLICATION

This application claims the benefit of U.S. Provisional Application No. 63/366,959, filed Jun. 24, 2022, the entire contents of which are incorporated herein by reference.

### BACKGROUND

The present disclosure pertains to an indexing system for positioning or distributing work products that the arrive in a single file stream to multiple workstations. One example of this situation is to distribute filled containers or cans to two side-by-side closure stations. The closure station can be in the form of two seaming head that seam a cover to the top of the container. Current technology for this function includes pneumatic cylinders that push the containers along on different tracks, one for each workstation. However, with pneumatic cylinders dead or lost time occurs due to the need to retract the cylinders in preparation to push the next container forward.

The present disclosure seeks to provide a solution to the need to feed the workstations with work product, wherein:
The feed mechanism uses a minimum of components, and so provides a cost-effective solution.
No lost/dead time is present; the only non-functional movement of the mechanism is established as soon as the previous can is on its position and can be executed very fast.
The spacing in between the arriving work products, e.g., containers, is of no importance.
The feed mechanism is flexible: when only one workstation is operating, the indexing mechanism can be replaced by a turret with pockets for the work product, that simply rotates to feed the single workstation.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an indexing system for a multi-station apparatus is provided for processing work products. The indexing system includes a multi-position indexing platform having a plurality of stations arranged along an arcuate path about an axis, the stations comprising a receiving station for receiving work products for processing, at least two processing stations where work products are processed, a first processing station positioned on the arcuate path extending clockwise from the receiving station toward the discharge station, and a second processing station positioned on the arcuate path extending counterclockwise from the receiving station toward the discharge station, and a discharge station from which work products that have been processed are removed from the platform, the discharge station located on the arcuate path downstream from the processing stations, and a pivot arm assembly rotatable about the axis to move the work products from the receiving station in a clockwise direction to the first processing station and in a counterclockwise direction to the second processing station.

In any of the embodiments described herein, wherein the pivot arm assembly when rotating about the axis to move the work products from the receiving station to a processing station, also moving processed work products from the processing station to the discharge station.

In any of the embodiments described herein, wherein the pivot arm assembly comprises a first pivot arm rotatable about the axis in clockwise and counterclockwise directions to move work products from the receiving station to the processing stations and from the processing stations to the discharge station.

In any of the embodiments described herein, wherein the first pivot arm is rotatable about the central axis in the clockwise direction to push work products from the receiving station to the first processing station and is rotatable about the central axis in the counterclockwise direction to push work products from the receiving station to the second processing station.

In any of the embodiments described herein, wherein when the first pivot arm is rotated about the axis in the clockwise direction to move work products from the receiving station to the first processing station, the first pivot arm is in position without further movement, to rotate about the central axis in the counterclockwise direction to move work products from the receiving station to the second processing station.

In any of the embodiments described herein, wherein the first pivot arm has portions defining a contact surface for bearing against the work products when pushing the work products from the receiving station to the first and second processing stations.

In any of the embodiments described herein, wherein the contact surface is shaped to correspond to the shape of the work product.

In any of the embodiments described herein, wherein the pivot arm assembly comprises a second pivot arm extending laterally from the first pivot arm and rotatable about the axis in the clockwise and counterclockwise directions to retain the work products against the first pivot arm as the work products move from the receiving station to the first and second processing stations.

In any of the embodiments described herein, wherein the second pivot arm moves the work product from the first and second processing stations to the discharge station as the first pivot arm moves the work products from the receiving station to the first and second processing stations.

In any of the embodiments described herein, wherein the second pivot arm is extendable relative to the first pivot arm to be disposed relative to the first pivot arm in a rotationally leading position as the first pivot arm rotates in the clockwise or counterclockwise directions.

In any of the embodiments described herein, wherein the distance that the second pivot arm extends relative to the first pivot arm is adjustable to correspond to the direction of rotation of the first pivot arm.

In any of the embodiments described herein, wherein the path along which the plurality of stations are arranged is a circular path about the axis,

In accordance with another embodiment of the present disclosure, a method of presenting work products to be processed to a multi-station processing apparatus and removing the processed work products from the processing apparatus is provided. The method includes receiving work products to be processed at a receiving station from a stream of work products to be processed, moving work products to be processed from the receiving station along an arcuate path in a clockwise direction to a first processing station and in a counterclockwise direction to a second processing station, and moving the work products after being processed along the arcuate path from the first processing station to the discharge station and from the second processing station to the discharge station.

In any of the embodiments described herein, wherein the arcuate path along which the work products to be processed are moved from the receiving station to the first and second processing stations and are moved from the first and second processing stations to the discharge station is a circular path.

In any of the embodiments described herein, wherein the receiving station and discharge station are positioned at diametrically opposite locations on the circular path.

In any of the embodiments described herein, wherein the work products are moved from the receiving station to the first and second processing stations along the arcuate path by a swing arm assembly rotatable about an axis.

In any of the embodiments described herein, wherein the swing arm assembly rotates in a first direction about the axis to move work products from the receiving station to the first processing station and rotates about the axis in a second direction to move work products from the receiving station to the second processing station.

In any of the embodiments described herein, wherein when the swing arm assembly has rotated in a first direction about the axis to move work products from the receiving station to the first processing station, the swing arm requires no further rotation about the axis to be in position to rotate about the axis in a second direction to move work products from the receiving station to the second processing station.

In any of the embodiments described herein, further comprising retaining the work products to the swing arm assembly as the swing arm assembly moves the work products from the receiving station to the first and second processing stations.

In accordance with another embodiment of the present disclosure, an indexing system for a multi-head seamer apparatus is provided for sealing the tops of containers with covers. The indexing system includes a multi-position indexing platform having a plurality of stations arranged along an arcuate path about an axis, the stations comprising a receiving station for receiving containers to which covers are to be sealed, and a discharge station from which containers with covers sealed thereto are removed from the platform, the receiving station and discharge station located on the arcuate path diametrically opposite to each other relative to the axis, and at least two sealing stations where at covers are sealed to the containers, a first sealing station positioned on the arcuate path extending clockwise from the receiving station toward the discharge station, and a second sealing station positioned on the arcuate path extending counterclockwise from the receiving station toward the discharge station, and a pivot arm assembly to rotatably toggle about the pivot axis to move the containers from the receiving station in a clockwise direction to the first sealing station and in a counterclockwise direction to the second sealing station.

In any of the embodiments described herein, wherein the pivot arm assembly, when rotating about the pivot axis to move the containers from the receiving station to a sealing station, also moves the sealed containers from the sealing station to the discharge station.

In any of the embodiments described herein, wherein the pivot arm assembly comprises a first pivot arm rotatable about the axis in clockwise and counterclockwise directions to move containers from the receiving station to the processing stations and from the processing stations to the discharge station.

In any of the embodiments described herein, wherein the first pivot arm is rotatable about the axis in the clockwise direction to move containers from the receiving station to the first sealing station and is rotatable about the central axis in the counterclockwise direction to move containers from the receiving station to the second sealing station.

In any of the embodiments described herein, wherein the first pivot arm is rotated about the axis in a clockwise to move containers from the receiving station to the first sealing station, whereupon the first pivot arm is in position without further movement to be rotated in a counterclockwise direction to move containers from the receiving station to the second sealing stations.

In any of the embodiments described herein, wherein the first pivot arm is rotatable about the central axis in the clockwise direction to push containers from the receiving station to the first sealing station and is rotatable about the central axis in the counterclockwise direction to push containers from the receiving station to the second sealing station.

In any of the embodiments described herein, wherein the first pivot arm has portions defining contact faces for bearing against the containers when pushing the containers from the receiving station to the first and second sealing stations.

In any of the embodiments described herein, wherein the contact faces are arcuate in shape to correspond to a curvature of the containers.

In any of the embodiments described herein, wherein the first pivot arm has portions defining contact faces for bearing against the containers when moving the containers from the receiving station to the first and second sealing stations.

In any of the embodiments described herein, wherein the contact faces are arcuate in shape to correspond to a curvature of the containers

In any of the embodiments described herein, wherein the pivot arm assembly comprises a second pivot arm extending laterally from the first pivot arm and rotatable about the central axis in the clockwise and counterclockwise directions to retain the containers against the first pivot arm as the containers move from the receiving station to the first and second sealing stations.

In any of the embodiments described herein, wherein the second pivot arm moves the containers from the first and second sealing station to the discharge station as the first pivot arm moves the containers from the receiving station to the first and second sealing stations.

In any of the embodiments described herein, wherein the second pivot arm is extendable relative to the first pivot arm to dispose the first pivot arm in a rotationally leading position relative to the first pivot arm as the first pivot arm rotates in the clockwise or counterclockwise directions.

In any of the embodiments described herein, wherein the distance that the second pivot arm extends relative to the first pivot arm is adjustable to correspond to the direction of rotation of the first pivot arm.

In any of the embodiments described herein, wherein the plurality of stations are arranged in a circular path about the axis,

In accordance with another embodiment of the present disclosure, a method of presenting containers to be closed to a multi-head container sealing apparatus and removing the closed containers from the multi-head container sealing apparatus is provided. The method comprises receiving containers to be sealed at a receiving station from a stream of containers to be sealed, moving containers to be sealed from the receiving station along an arcuate path in a clockwise direction to a first sealing station and in a counterclockwise direction to a second sealing station, and moving the containers after being sealed along the arcuate path from the first sealing station to the discharge station and from the second sealing station to the discharge station.

In any of the embodiments described herein, wherein the arcuate path along which the containers to be sealed are moved from the receiving station to the first and second sealing stations and are moved from the first and second sealing stations to the discharge station is a circular path.

In any of the embodiments described herein, wherein the receiving station and discharge station are positioned at diametrically opposite locations on the circular path.

In any of the embodiments described herein, wherein the containers are moved from the receiving station of the first and second processing stations along the arcuate path by a swing arm assembly rotatable about an axis.

In any of the embodiments described herein, wherein the swing arm assembly rotates in a first direction about the axis to move the containers from the receiving station to the first sealing station, and rotates about the axis in a second direction to move the containers from the receiving station to the second sealing station.

In any of the embodiments described herein, wherein when the swing arm assembly has rotated in in a first direction about the axis to move containers from the receiving station to the first sealing station, the swing arm requires no further rotation about the axis to be in position to rotate about the axis in a second direction to move containers from the receiving station to the second sealing station.

In any of the embodiments described herein, further comprising retaining the containers to the swing arm assembly as the swing arm assembly moves the containers from the receiving station to the first and second sealing stations.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic isometric view of a multi-station processing apparatus with an indexing system in accordance with the present disclosure;

FIG. 2 is a schematic top isometric view of the indexing system of FIG. 1;

FIG. 3 is a top view of FIG. 2;

FIGS. 4A to 4H are schematic views of the positions of the indexing system of FIGS. 1-3.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

The present application may refer to “product,” “work product,” “workpiece” synonymously. Examples of a product, work product or workpiece described in the present application include containers and cans. But the present disclosure is not limited to containers or cans, but may include all manner of work products as described herein.

Also, the present application provides as one example the seaming of tops to cans. As described herein the indexing system of the present application is not limited for use for this purpose. Rather, numerous other operations can be performed with respect to the containers or cans, as described herein. Further, innumerable different operations or processes can be carried out at the work stations to which work products are delivered to and removed from, using the indexing system of the present disclosure.

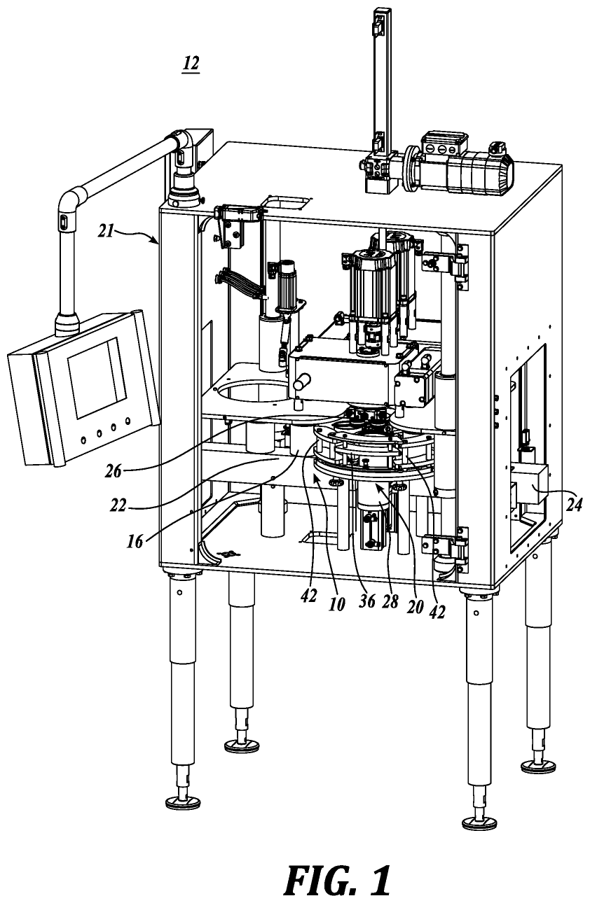

FIGS. 1-3 shows an indexing system 10 according to the present disclosure installed in conjunction with a multi-station processing apparatus 12. Although the processing apparatus 12 is shown in the form of an apparatus for seaming (sealing) covers 14 to the tops of containers in the form of cans 16, the indexing system can be used with all manner of processing apparatus. For example, the processing apparatus may attach covers or tops to cans and other types of containers by techniques other than by seaming, for example by gluing, heat fusing, twisting, screwing, stamping, etc. Further, the apparatus may perform a process other than the closing of a container, such as filling or adding contents to the container, or the apparatus may perform other types of processes on a wide range of work pieces that are not containers or cans, such as welding a work piece, painting a work piece, machining a work piece, assembling a work piece, inspecting a work piece, etc. The indexing system 10 is able to quickly, efficiently, and reliably move or transfer work pieces from a receiving station to multiple processing stations for processing and then move or transfer the processed work pieces to a discharge station in a space efficient manner.

FIGS. 1-3 provide an example of a possible configuration and use of the indexing system 10 of the present disclosure. In this regard, the indexing system 10 includes a multi-position platform or table 20 mounted within a housing 21. The platform is disposed in alignment with an infeed or receiving conveyance in the form of conveyor 22 and an outfeed or discharge conveyance in the form of conveyor 24. Openings are provided in the housing to provide clearance for the infeed and outfeed conveyors 22 and 24.

Although the conveyors 22 and 24 are schematically shown, the conveyors can be of standard construction, composed of endless belts 30 and 32 that train around end rollers, with one of the end rollers being powered or driven in a standard manner, for example, by electric motors, hydraulic motors or pneumatic motors. Between the end rollers, the belts 30 and 32 can be supported by idler rollers, a slider bed, or by other structure in a standard manner.

An infeed or receiving station 44 of the system 10, for the containers 16, is defined by the intersection of the infeed or receiving conveyor 22 and the table 20. Correspondingly an outfeed or discharge station 46 of the system 10, for the containers 16, is defined by the intersection of the outfeed or discharge conveyor 24 and the table 20. To this end, openings may be formed in the platform 20 to provide clearance for the adjacent ends of the conveyors 22 and 24.

The platform 20 is positioned beneath a can seaming apparatus 12 configured as having two overhead seaming heads 26 positioned relative to each other in a direction laterally to the longitudinal direction of the infeed conveyor 22, see FIG. 3. The locations on the platform beneath the seaming heads correspond to first and second processing stations 48 and 50, respectively. The seaming heads function to seam the covers 14 on to the tops of the containers (cans).

Lift mechanisms 28 are positioned below and beneath the platform 20 at processing stations 48 and 50 to lift the containers 16 to be sealed up to the overhead seaming heads 26 so that the covers 14 can be sealed to the containers by a standard seaming process. Thereafter, the lift mechanisms 28 lower the sealed containers 16 back down to the elevation of the platform 20 so that the containers 16 can be moved to the outfeed station and placed on the outfeed conveyor 24.

Openings are formed in the platform at processing stations 48 and 50 to receive close fitting circular pads 52 on which the containers 16 are placed. The pads 52 are raised toward and lowered from the seaming heads 26 by the lift mechanisms 28. When in lowered position, the tops surfaces of the pads are substantially co-planar with the top surface of the platform 20.

The lift mechanisms 28 may include actuators for raising and lowering the pads 52. Such actuators may be of numerous different types, including, for example, pneumatic or hydraulic cylinders, motor driven leadscrews, magnetic coil linear actuators.

The platform 20 is shown as being generally circular in shape, but can be of other shapes, such as, for example, hexagonal or octagonal or pentagonal. The top surface of the platform is depicted as substantially co-planar with the upper runs of the belts 30 and 32 of the conveyors 22 and 24 to facilitate transfer to the containers 16 from the infeed conveyor 22 to the table 20 at the infeed station 44 and from the table to the outfeed conveyor 24 at the outfeed station 46.

A retaining fence 36 can extend along the perimeter of the generally circular platform 20 corresponding to each side of the conveyors 22 and 24, thereby, if necessary to retain the containers 16 on the platform 20 as the containers travel from the infeed station 44 to the processing stations 48 and 50 and thereafter from the processing stations to the outfeed station 46.

As shown in FIG. 1, the fence 36 may be composed of vertically spaced-apart upper and lower arcuate rail sections 40 supported above the platform 20 by upright posts 42. If needed, the fence 36 can retain containers 16 on platform 20 as the containers travel from the infeed station 44 to processing stations 48 and 50 located at the seaming heads 26, as well as when the seamed containers 16 travel from the processing stations 48 and 50 to the outfeed station 46. Of course, the fence 36 can be of constructions different from that described above and perform the desired function.

The containers 16 are moved from the infeed station 44 to the processing stations 48 and 50 and from the processing stations to the outfit station 46 by pivot arm assembly 60 that pivots about a central axis 62. When the arm assembly pivots in a first direction, e.g., clockwise, the container 16 is moved from the infeed station 44 to the first processing station 48. Correspondingly, when the pivot arm assembly pivots in the opposite direction, e.g., counterclockwise, the container is moved from the infeed station 44 to the second processing station 50. Thus, in this manner, the pivot arm assembly 60 can toggle clockwise and counterclockwise about axis 62 to alternatively transfer containers from the infeed station 44 to the first and second processing stations 48 and 50.

The pivot arm assembly 60 includes first pivot arm 64 constructed with the substantial circular base section 66 centered at axis 62 to pivot relative thereto. The pivot arm 64 also includes a contoured shank suction 68 extending radially from the circular base section 66 toward the outer perimeter of the platform 20. The sides of the shrank section are contoured to correspond to be outer circumference of the containers 16. If the containers 16 are of a shape other than cylindrical as shown in the figures, the sides of the shank section 68 can be contoured to be compatible with the shape of the container or other work product being handled by the indexing system 10.

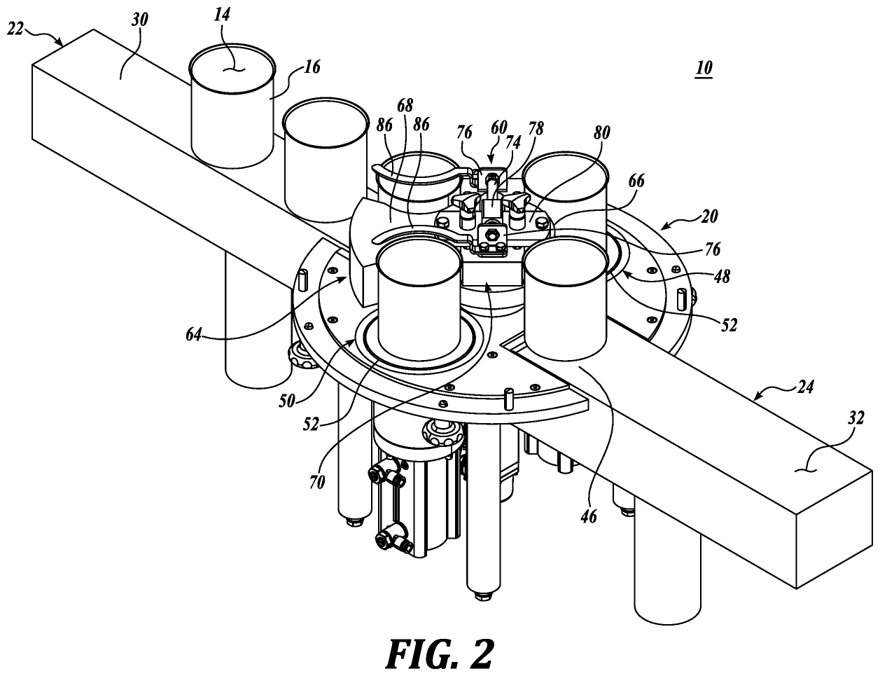

As shown in FIGS. 2 and 3, the first pivot arm is sized and shaped so that the opposite sides of the shank section 68 closely correspond to the outer circumferences of the container 16 positioned at the infeed station as well as the container 16 positioned at the first or second processing stations 48 and 50.

In the situation shown in FIGS. 2 and 3, the sides of the shank section 68 extend sufficiently around the circumference of the container 16 so as to hold the container captive against the curved side of the shank section with the assistance of a second pivot arm 70 which extends transversely from the base section 66 of the first pivot arm 64 relative to the length of the first pivot arm.

The second pivot arm 70 may be mounted on the first pivot arm 64 to move or shuttle longitudinally along its length relative to the first pivot arm so as to extend from a first side of the first pivot arm or alternatively form the opposite side of the first pivot arm. In this manner, the second pivot arm cooperates with the side of the first pivot arm that is being used to index transfer (push) the container from the infeed station to the one of the processing stations.

For example, as shown in FIG. 3, the first pivot arm is in position to transfer the container 16 from the infeed station 44 to the first processing station 48. As such, the second pivot arm is extended so as to be disposed between the infeed station and the first processing station, or in other words in a “leading” position relative to the direction of rotation of the first pivot arm 64. In this position, the second pivot arm 70 holds the container against the curved shank portion 68 of the first pivot arm 64 as the container is transferred from the infeed station 44 to the first processing station 48. Also, the opposite end of the second pivot arm is within the perimeter of the first arm circular base section 66 so as not to interfere with the containers that may be positioned at the second processing station 50 or at the outfeed station 46.

Moreover, the width of the second pivot arm is sized to fit closely between the containers at the infeed station and the first or second processing station. As such, when the pivot arm assembly is rotated to move a container from the infeed station to the first or second processing station, the container currently at the first or second processing station is simultaneously moved (pushed) by the extended section of the second pivot arm to the outfeed station.

The second pivot arm is mounted within a cross slot 72 formed in the base section 66 of the first pivot arm to shuttle back and forth along is length there by to extend beyond one side of the first pivot arm or the other side of the first pivot arm, depending on the direction of rotation of the first pivot arm. As noted above the second pivot arm is actuated to be in a rotationally leading position relative to the first pivot arm regardless of whether the first pivot arm is rotating in the clockwise or counterclockwise direction.

The second pivot arm includes a guide rod 74 that extends centrally along the length of the second pivot arm at an elevation above the top surface of the second pivot arm. The ends of the guide rod are held in place by brackets 76 extending upwardly from the end portions of the second pivot arm. The guide rod extends through a centrally located, close fitting guide block 78 so that the second pivot arm is restrained to move longitudinally along its length. The guide block is mounted on a cross-plate 80, which in turn is mounted to the base section 66 of the first pivot arm on opposite sides of slot 72.

The second pivot arm may be powered to shuttle back and forth by various actuating systems, including, for example, a pneumatic actuator or magnetic coil actuator or a piezoelectric actuator, all of which are well known and can take the configuration of the guide rod 74 and guide block 78.

Longitudinal side slots 82 are formed along the length of the second pivot arm to provide clearance for hardware members used to attach the pivot arm assembly 60 to the flange of a motor that operates to pivot the pivot arm assembly. Manually operable twist knobs 84 are provided to tighten or loosen the hardware members.

Curved retaining arms 86 extend laterally from each end portion of the second pivot arm 70 to extend over the container 16 which is being transferred from the infeed station 44 to either the first or second processing station 48 or 50. The retaining arms 86 prevent the cover 14 from dislodging from the container 16 under the acceleration imposed on the container when being transferred from the infeed station 44 to the first or second processing station 48/50.

As shown, the retaining arms 86 include a longitudinal mounting section that is attached to the top surface of the second pivot arm by hardware members 88. The retaining arms 86 also include a curved projecting section which extends closely over the tops of the container 16 and cover 14. The curved projecting sections are shaped and sized to extend partially around, but spaced from, the container 16 positioned at the first or second processing station 48/50 corresponding to the retracted end of the second pivot arm 70 so as to not interfere with the container. Of course, the retaining arms 86 can be shaped or otherwise configured differently than as illustrated while performing the required function.

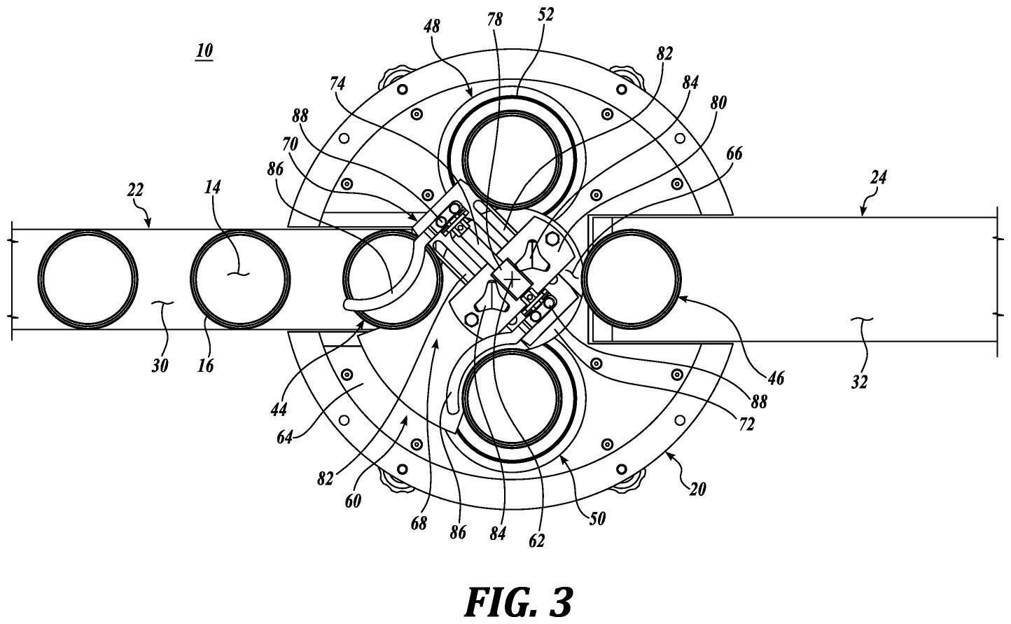

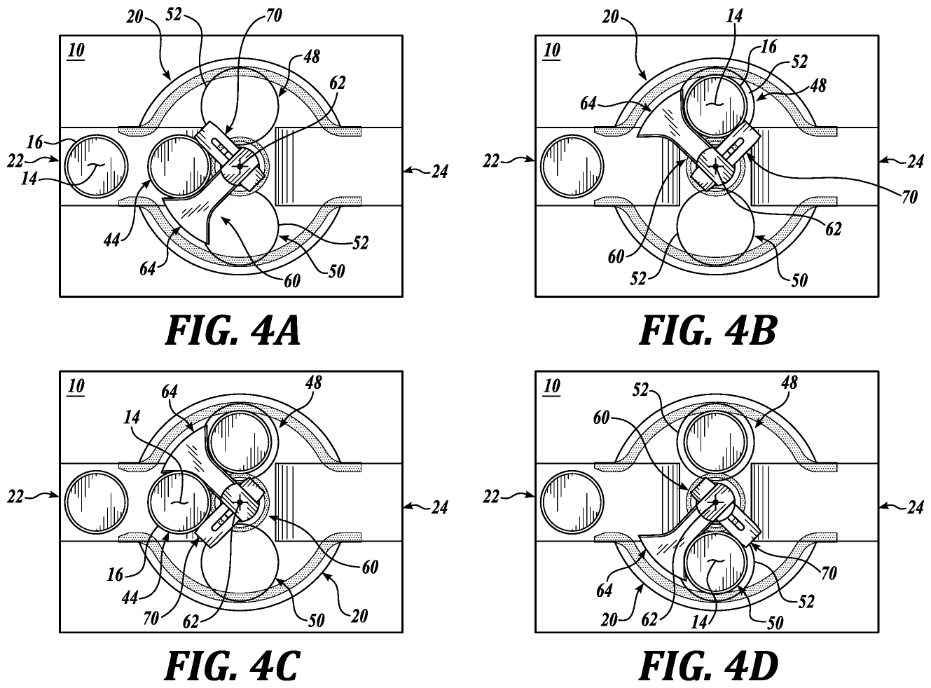

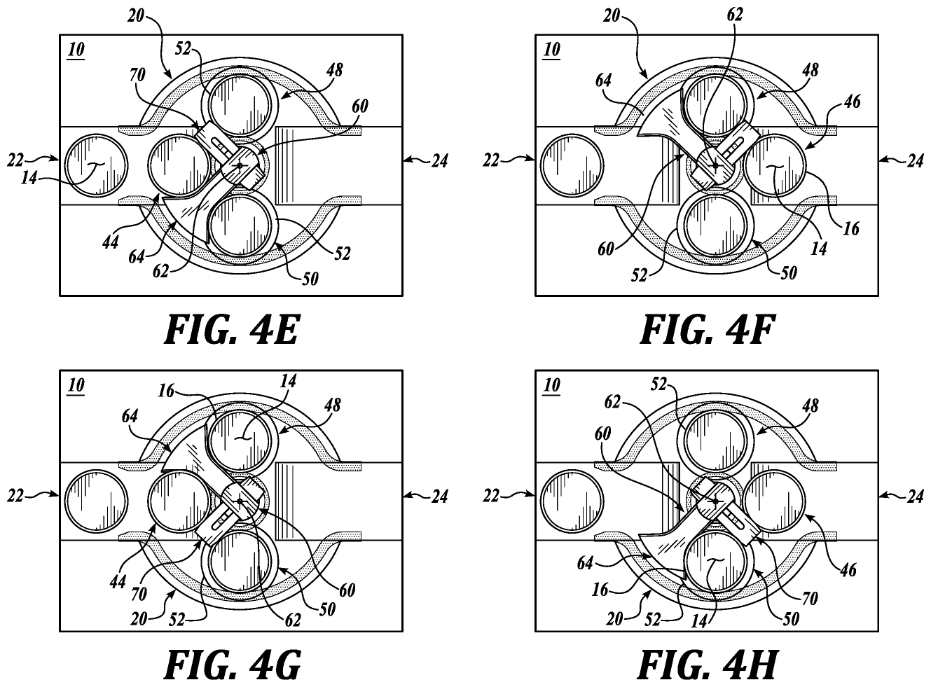

The operation of the indexing system 10 is illustrated in FIGS. 4A-4H, wherein FIG. 4A shows the starting position of the system with a container 16 is positioned at the infeed station 44. The first pivot arm 64 is located at a diagonally downward orientation so as to be in position to push the container 16 clockwise from the infeed station 44 to the first processing station 48. Correspondingly, the second pivot arm 70 is extended to be disposed in a diagonally upwardly orientation to be positioned at the side of the container 16 opposite to the location of the first pivot arm 64.

FIG. 4B shows the container 16 being moved (pushed) clockwise from the infeed station 44 to the first processing station 48 by rotation of first and second pivot arms 64 and 70 about axis 62.

FIG. 4C shows a second container 16 advanced forwardly to be at the infeed station 44. The first pivot arm 64 remains in the same position as in FIG. 4B. However, the second pivot arm 70 is shuttled to extend diagonally downwardly so as to be positioned on the side of the container 16 opposite to the location of the first pivot arm 64 before the container 16 is advanced to the infeed station 44.

FIG. 4D shows the container 16 being moved counterclockwise from the infeed station 44 to the second processing station 50 by rotation of the first and second pivot arms 64 and 70 about axis 62.

FIG. 4E shows further container 16 advanced to the infeed station 44, while the first pivot arm remains in the position shown in FIG. 4D. However, the second pivot arm has been shuttled to extend diagonally upwardly so as to be on the side of the container 16 opposite to the location of the first pivot arm 64, thereby being in position to transfer the container from the infeed station clockwise to the first processing station 48. Also, the second pivot arm 70 is adjacent to the container at the first processing station 48.

FIG. 4F shows that the container 16 which was at the infeed station in FIG. 4E is pushed clockwise to the first processing station 48 by rotation of the first and second pivot arms 64 and 70 about axis 62. Simultaneously, the container 16, which was at the first processing station 48, is moved further clockwise to the outfeed station 46 by being pushed thereto by the rotation of the second pivot arm 70.

FIG. 4G shows that a further container 16 has been positioned at the infeed station 44 so as to be ready for movement to the second processing station 50. In this regard, the first pivot arm 64 is in the same position as in FIG. 4F; however, the second pivot arm 70 has been shuttled to now extend into a diagonally downward position so as to be located between the container at the infeed station 44 and the container located at the second processing station 50. Also, the container 16 that was at the outfit station 46 in FIG. 4F has now been removed by the outfeed conveyor 24

FIG. 4H shows that the container 16 at the infeed station 44 in FIG. 4G has been pushed counterclockwise to the second processing station 50 by rotation of the first and second pivot arms 64 and 70 arms about axis 62. Simultaneously, the container 16, which was at the second processing station 48, is moved further counterclockwise by the second pivot arm to the outfeed station 46.

As shown in FIGS. 4A to 4H, the indexing system 10 operates to rapidly transfer containers 16 from the infeed station 44 to the first and second processing stations 48 and 50 in an efficient manner, with a minimum of moving parts and no lost motion. In this regard, the first pivot arm moves (pushes) a container from an infeed location to a processing location with each 90 degree pivot rotation. There is no lost “return” movement of the first pivot arm as would be the case if, for example, a pneumatic actuator was used to push containers along different tracks aligned with the two processing stations 48 and 50.

Further, processed containers 16 are efficiently moved from the first and second processing stations 48 and 50 to the outfeed station 46 at the same time, and with the same rotation of the pivot arms 64 and 70 used to move the containers to and from the infeed station to the processing stations 48 and 50.

Although the forgoing description concerns moving containers 16 to stations 48 and 50 for various types of processing, such as filling the container or attaching/seaming covers on the containers, the indexing system 10 of the present disclosure can be used for indexing innumerable types of work products from an infeed station to multiple processing stations, for example, for indexing parts or components for welding, brazing, soldering, gluing, painting, nailing, drilling, milling, grinding, boring, reaming, polishing, or other type(s) of machining operations.

While illustrative embodiments have been illustrated and described, it will be appreciated that various changes can be made therein without departing from the spirit and scope of the invention.

1. An indexing system for a multi-station apparatus for processing work products, the indexing system comprising:
a multi-position indexing platform having a plurality of stations arranged along an arcuate path about an axis, the stations comprising:
a receiving station for receiving work products for processing,
at least two processing stations where work products are processed, a first processing station positioned on the arcuate path extending clockwise from the receiving station toward the discharge station, and a second processing station positioned on the arcuate path extending counterclockwise from the receiving station toward the discharge station; and
a discharge station from which work products that have been processed are removed from the platform, the discharge station located on the arcuate path downstream from the processing stations; and
a pivot arm assembly rotatable about the axis to move the work products from the receiving station in a clockwise direction to the first processing station and in a counterclockwise direction to the second processing station.

2. The indexing system of claim 1, wherein the pivot arm assembly when rotating about the axis to move the work products from the receiving station to a processing station, also moving processed work products from the processing station to the discharge station.

3. The indexing system of claim 1, wherein the pivot arm assembly comprises a first pivot arm rotatable about the axis in clockwise and counterclockwise directions to move work products from the receiving station to the processing stations and from the processing stations to the discharge station.

4. The indexing system of claim 3, wherein the first pivot arm is rotatable about the central axis in the clockwise direction to push work products from the receiving station to the first processing station and is rotatable about the central axis in the counterclockwise direction to push work products from the receiving station to the second processing station.

5. The indexing system of claim 4, wherein when the first pivot arm is rotated about the axis in the clockwise direction to move work products from the receiving station to the first processing station, the first pivot arm is in position without further movement, to rotate about the central axis in the counterclockwise direction to move work products from the receiving station to the second processing station.

6. The indexing system of claim 3, wherein the first pivot arm has portions defining a contact surface for bearing against the work products when pushing the work products from the receiving station to the first and second processing stations.

7. The indexing system of claim 6, wherein the contact surface is shaped to correspond to the shape of the work product.

8. The indexing system of claim 3, wherein the pivot arm assembly comprises a second pivot arm extending laterally from the first pivot arm and rotatable about the axis in the clockwise and counterclockwise directions to retain the work products against the first pivot arm as the work products move from the receiving station to the first and second processing stations.

9. The indexing system of claim 3, wherein the second pivot arm moves the work product from the first and second processing stations to the discharge station as the first pivot arm moves the work products from the receiving station to the first and second processing stations.

10. The indexing system of claim 8, wherein the second pivot arm is extendable relative to the first pivot arm to be disposed relative to the first pivot arm in a rotationally leading position as the first pivot arm rotates in the clockwise or counterclockwise directions.

11. The indexing system of claim 8, wherein the distance that the second pivot arm extends relative to the first pivot arm is adjustable to correspond to the direction of rotation of the first pivot arm.

12. The indexing system of claim 1, wherein the path along which the plurality of stations are arranged is a circular path about the axis,

13. A method of presenting work products to be processed to a multi-station processing apparatus and removing the processed work products from the processing apparatus, comprising:
receiving work products to be processed at a receiving station from a stream of work products to be processed;
moving work products to be processed from the receiving station along an arcuate path in a clockwise direction to a first processing station and in a counterclockwise direction to a second processing station; and
moving the work products after being processed along the arcuate path from the first processing station to the discharge station and from the second processing station to the discharge station.

14. The method of claim 13, wherein the arcuate path along which the work products to be processed are moved from the receiving station to the first and second processing stations and are moved from the first and second processing stations to the discharge station is a circular path.

15. The method of claim 14, wherein the receiving station and discharge station are positioned at diametrically opposite locations on the circular path.

16. The method of claim 13, wherein the work products are moved from the receiving station to the first and second processing stations along the arcuate path by a swing arm assembly rotatable about an axis.

17. The method of claim 16, wherein the swing arm assembly rotates in a first direction about the axis to move work products from the receiving station to the first processing station and rotates about the axis in a second direction to move work products from the receiving station to the second processing station.

18. The method of claim 16, wherein when the swing arm assembly has rotated in a first direction about the axis to move work products from the receiving station to the first processing station, the swing arm requires no further rotation about the axis to be in position to rotate about the axis in a second direction to move work products from the receiving station to the second processing station.

19. The method of claim 16, further comprising retaining the work products to the swing arm assembly as the swing arm assembly moves the work products from the receiving station to the first and second processing stations.

20. An indexing system for a multi-head seamer apparatus for sealing the tops of containers with covers, the indexing system comprising:
a multi-position indexing platform having a plurality of stations arranged along an arcuate path about an axis, the stations comprising:
a receiving station for receiving containers to which covers are to be sealed, and a discharge station from which containers with covers sealed thereto are removed from the platform, the receiving station and discharge station located on the arcuate path diametrically opposite to each other relative to the axis; and
at least two sealing stations where at covers are sealed to the containers, a first sealing station positioned on the arcuate path extending clockwise from the receiving station toward the discharge station, and a second sealing station positioned on the arcuate path extending counterclockwise from the receiving station toward the discharge station; and
a pivot arm assembly to rotatably toggle about the pivot axis to move the containers from the receiving station in a clockwise direction to the first sealing station and in a counterclockwise direction to the second sealing station.

21-41. (canceled)
